(19) United States
(12) Patent Application Publication
(10) Pub. No.: US 2025/0180812 A1
(43) Pub. Date: Jun. 5, 2025

(54) DEVICE FOR COUPLING A LASER BEAM INTO A MULTI-CLAD FIBRE AND OPTICAL SYSTEM

(71) Applicant: TRUMPF Laser GmbH, Schramberg (DE)

(72) Inventors: Julian Hellstern, Rottweil (DE); Tina Gottwald, Eschbronn (DE); Francesco D’Angelo, Mainz (DE)

(21) Appl. No.: 19/044,647

(22) Filed: Feb. 4, 2025

Related U.S. Application Data
(63) Continuation of application No. PCT/EP2023/061087, filed on Apr. 27, 2023.

(30) Foreign Application Priority Data
Aug. 4, 2022 (DE) 10 2022 119 556.2

(51) Int. Cl. G02B 6/27

(52) U.S. Cl. CPC G02B 6/2713

(57) ABSTRACT

A device for coupling a laser beam into a multi-clad fiber includes a beam switch for dividing the laser beam into a plurality of sub-laser-beams. The beam switch includes at least two birefringent optical wedges, and at least one polarization-influencing device having an adjustable polarization-influencing effect and being arranged between the at least two birefringent optical wedges. The device further includes an in-coupling optical unit for coupling the plurality of sub-laser-beams exiting the beam switch into the multi-clad fiber. The in-coupling optical unit is configured to couple at least two of the plurality of sub-laser-beams exiting the beam switch into at least two different light-conducting cores of the multi-clad fiber.

### CROSS REFERENCE TO RELATED APPLICATIONS

This application is a continuation of International Application No. PCT/EP2023/061087 (WO 2024/027963 A1), filed on Apr. 27, 2023, and claims benefit to German Patent Application No. DE 10 2022 119 556.2, filed on Aug. 4, 2022. The aforementioned applications are hereby incorporated by reference herein.

### FIELD

Embodiments of the present invention relate to a device for coupling a laser beam into a multi-clad fiber. Embodiments of the present invention also relate to an optical system having such a device and a multi-clad fiber.

### BACKGROUND

A multi-clad fiber can be used to guide a laser beam from a source location to a target location. The source location can, for example, be a laser that is used to generate the laser beam. The target location can, for example, be a processing optics that shapes the laser beam and then applies the laser beam to a workpiece in order to machine it. The machining process can, for example, be a welding process or a cutting process.

Different machining processes usually have different requirements for characteristic laser beam parameters, such as the focus diameter, the intensity distribution, the beam profile, etc.

It is known from EP2556397 that the laser beam components coupled into the inner core or the outer core of a multi-clad fiber provide different beam characteristics and beam qualities in the out-coupled laser beam. In order to adjust the beam quality, the laser beam is split into two sub-laser-beams by a mechanically retractable wedge beam switch, said sub-laser-beams being coupled into different cores of the double-clad fiber. However, the wedge beam switch for adjusting the beam quality is difficult to manufacture and the distribution of power between the inner core and the outer core is affected by changes in the position of the laser beam on the wedge beam switch (misalignment sensitivity).

U.S. Ser. No. 10/914,902 describes various variants of coupling a laser beam into a double-clad fiber, in which a polarization splitting of an incident laser beam is achieved by means of birefringent elements and the two resulting sub-laser-beams are mapped into different cores of the double-clad fiber.

### SUMMARY

Embodiments of the present invention provide a device for coupling a laser beam into a multi-clad fiber. The device includes a beam switch for dividing the laser beam into a plurality of sub-laser-beams. The beam switch includes at least two birefringent optical wedges, and at least one polarization-influencing device having an adjustable polarization-influencing effect and being arranged between the at least two birefringent optical wedges. The device further includes an in-coupling optical unit for coupling the plurality of sub-laser-beams exiting the beam switch into the multi-clad fiber. The in-coupling optical unit is configured to couple at least two of the plurality of sub-laser-beams exiting the beam switch into at least two different light-conducting cores of the multi-clad fiber.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic representation of an optical system having a multi-clad fiber and a device for coupling a laser beam into the multi-clad fiber according to some embodiments;

FIG. 2 shows a schematic representation of a laser beam passing through a birefringent optical wedge of a beam switch of the device of FIG. 1 according to some embodiments;

FIG. 3 shows a schematic representation analogous to FIG. 1, in which the device is designed to couple the laser beam into a double-clad fiber according to some embodiments;

FIG. 4a, FIG. 4b, and FIG. 4c show schematic representations analogous to FIG. 1, in which the device is designed to couple the laser beam into a triple-clad fiber according to some embodiments;

FIG. 5 shows a schematic representation analogous to FIGS. 4a-4c, in which the device is designed to couple the laser beam into a quadruple-clad fiber according to some embodiments; and

FIG. 6 shows a schematic representation analogous to FIG. 1 having a further device designed to couple the laser beam into a quadruple-clad fiber according to some embodiments.

### DETAILED DESCRIPTION

Embodiments of the invention provide an improved device for coupling a laser beam into a multi-clad fiber and a corresponding optical system.

According to some embodiments, a device for coupling a laser beam, comprising: a beam switch for dividing the laser beam into a plurality of sub-laser-beams, wherein the beam switch comprises at least two birefringent optical wedges and at least one polarization-influencing device which has an adjustable polarization-influencing effect and which is arranged between the birefringent optical wedges, as well as an in-coupling optical unit for coupling the sub-laser-beams exiting the beam switch into the multi-clad fiber, wherein the in-coupling optical unit is designed to couple at least two of the sub-laser-beams exiting the beam switch into at least two different light-conducting cores of the multi-clad fiber.

With the device described here, at least two birefringent optical wedges are used to split the laser beam into several sub-laser-beams. This takes advantage of the fact that an ordinary and an extraordinary sub-laser-beam are formed in a birefringent optical wedge, which exhibit a difference angle when exiting a beam exit surface of the birefringent optical wedge. The two sub-laser-beams exiting the birefringent wedge are linearly polarized and have a mutually perpendicular direction of polarization. The birefringent material of the birefringent optical wedges is preferably a uniaxial crystal, such as calcite or quartz. The optical axis of the crystal is typically aligned perpendicular to the optical axis of the beam switch. A beam entry surface or a beam exit surface of the birefringent optical wedges is typically also aligned perpendicular to the optical axis of the beam switch.

When passing through the polarization-influencing device, the direction of polarization of the two linearly polarized sub-laser-beams exiting the birefringent optical wedge is influenced or manipulated such that the weighting of the s-polarized and p-polarized components of the sub-beams is changed. When passing through a subsequent birefringent optical wedge in the beam path, a respective sub-laser-beam is therefore split again into an ordinary and an extraordinary sub-laser-beam. When using, for example, two birefringent optical wedges in the beam switch, a maximum of four sub-laser-beams can be generated, which are aligned at several different angles with respect to the optical axis of the beam switch.

With the help of the in-coupling optical unit, the angular distribution of the sub-laser-beams is converted into a spatial distribution at an end face of the multi-clad fiber. The exit angles of the sub-laser-beams from the beam switch are matched to the in-coupling optical unit and lead to spatial offsets in the focal plane of the in-coupling optical unit, which are matched to the geometry of the multi-clad fiber in such a way that the sub-laser-beams are coupled into the multi-clad fiber at the positions of the light-conducting cores. The in-coupling optical unit can have one or more optical elements. The in-coupling optical unit typically comprises at least one focusing optical element for focusing the sub-laser-beams in a focal plane, at which the end face of the multi-clad fiber into which the laser beam is to be coupled is located.

The polarization-influencing device can, for example, be a rotatable delay element in the form of a delay plate, for example in the form of a λ/2 plate or a λ/4 plate. A delay plate generally causes a phase shift between two mutually perpendicular directions of polarization. A λ/2 plate causes a rotation of the direction of polarization of a respective linearly polarized sub-beam, a λ/4 plate can convert a respective linearly polarized sub-beam into a circularly or elliptically polarized sub-beam. In order to set a splitting ratio between 0% and 100% (see below), it is advantageous if the polarization-influencing device is designed as a polarization-rotating device, for example as a rotatable λ/2 plate. A rotatable λ/4 plate typically only allows the setting of a splitting ratio in a reduced range of values, for example between 50% and 100%.

The division of the power of the laser beam with the aid of the polarization-influencing device(s) has the advantage over the use of a mechanically retractable wedge beam switch that no scattered light and no diffraction effects occur at the edge of the mechanically retractable wedge. The distribution of the power of the laser beam to the various light-conducting cores can also be varied by setting the polarization-influencing effect of the polarization-influencing device. For example, if the polarization-influencing device is set such that it has no polarization-influencing effect, a number of sub-laser-beams can be generated that is half the maximum possible number of sub-laser-beams that can be generated with the beam switch (for example two instead of four sub-laser-beams when using two birefringent optical wedges). This can be used to prevent any power or sub-laser-beams from being coupled into certain light-conducting cores of the multi-clad fiber. For the purposes of this application, “different” light-conducting cores are understood to mean cores that are spatially positioned differently or that are spatially separated from one another.

The number of polarization-influencing devices corresponds to the number of degrees of freedom when coupling into the multi-clad fiber. It is advantageous if the number of polarization-influencing devices corresponds to the number of light-conducting cores of the multi-clad fiber minus one. In this case, between 0% and 100% of the power of the laser beam can usually be coupled into a respective light-conducting core of the multi-clad fiber.

In one embodiment, the multi-clad fiber is designed to be rotationally symmetrical and has an inner light-conducting core and at least one annular light-conducting core, and the in-coupling optical unit is designed to couple two sub-laser-beams exiting the beam switch with different polarization states, the propagation direction of which corresponds to a beam direction of the laser beam entering the beam switch, into the inner core of the multi-clad fiber.

In principle, the multi-clad fiber can be designed in different ways, for example in the form of a linear multi-clad fiber in which several light-conducting cores are arranged next to one another, or in the form of a grid-like multi-clad fiber in which several cores are arranged in rows and columns. For the sake of simplicity, the following description assumes that the multi-clad fiber is a rotationally symmetrical multi-clad fiber having an inner, typically circular light-conducting core and one or more annular light-conducting cores surrounding the inner light-conducting core. So-called intermediate claddings, which are not light-conducting, are installed between the light-conducting cores. The radially outermost light-conducting core can also be surrounded on its outside by a non-light-conducting cladding, to which a layer of glass or the like may be attached.

The two sub-laser-beams that are coupled into the inner core of the multi-clad fiber are those sub-laser-beams that are formed at the exit of the first birefringent optical wedge and retain their polarization state when passing through the beam switch. The different polarization states are therefore typically the linear polarization states aligned perpendicular to one another of the two sub-laser-beams exiting the first birefringent optical wedge. In this case, the beam switch is typically designed in such a way that the deflection angles of the two sub-laser-beams, which retain their polarization state when passing through the beam switch, just compensate one another when passing through the two or more birefringent optical wedges.

In the event that the laser beam is aligned parallel to the optical axis of the beam switch, the two exiting sub-laser-beams, in which the deflection angles just compensate one another, are also aligned parallel to the optical axis of the beam switch, but are laterally offset from the incident laser beam. In order to couple the two sub-laser-beams into the inner core of the multi-clad fiber, the in-coupling optical unit typically focus these two sub-laser-beams on the optical axis of the in-coupling optical unit, on which the inner core of the multi-clad fiber is positioned. The other sub-laser-beams exiting the beam switch, which are not aligned parallel to the incident laser beam, are coupled into the annular light-conducting core(s) of the multi-clad fiber. The optical axis of the in-coupling optical unit can, in principle, coincide with the optical axis of the beam switch. As a rule, however, it is advantageous if the optical axis of the in-coupling optical unit is laterally offset from the optical axis of the beam switch. The lateral offset of the optical axis of the in-coupling optical unit to the optical axis of the beam switch typically corresponds substantially to the lateral offset of the two sub-laser-beams, where the deflection angles just compensate one another, to the incident laser beam.

In a further embodiment, the device is designed to couple one or more pairs of sub-laser-beams with two different polarization states into a respective light-conducting core of the multi-clad fiber. The two polarization states are typically linear, mutually perpendicular polarization states, which are referred to below as s-polarization and p-polarization for the sake of simplicity. The pairwise coupling of sub-laser-beams with mutually perpendicular polarization states allows for a polarization-independent coupling of the sub-laser-beams into the respective light-conducting core. Such a type of coupling is particularly possible when using a rotationally symmetrical multi-clad fiber, in which a sub-laser-beam can be coupled into the respective annular cores at two positions opposite one another in the radial direction in each case. For the polarization-independent coupling, it is necessary that the number of birefringent optical wedges corresponds at least to the number of light-conducting cores of the multi-clad fiber. In the event that a polarization-independent coupling is omitted, the number of wedges can be one less than the number of light-conducting cores of the multi-clad fiber.

In one embodiment, the beam switch has a first number of birefringent optical wedges with the same orientation and a second number of birefringent optical wedges, which are oriented opposite to the first number of birefringent optical wedges, wherein the sum of the wedge angles of the first number of birefringent optical wedges corresponds to the sum of the wedge angles of the second number of birefringent optical wedges.

The same orientation of two or more birefringent optical wedges means that their wedge tips are positioned on the same side of the optical axis or beam direction of the laser beam. An opposite orientation is to be understood such that the wedge tips of the respective birefringent optical wedges are arranged on opposite sides with respect to the optical axis. The birefringent optical wedges in this case are typically made of the same birefringent material and the optical axes of the birefringent optical wedges are aligned parallel to one another. It is to be understood that the birefringent optical wedges do not necessarily have to have a wedge tip, as long as this is not passed through by the laser beam or the sub-laser-beams. In this case, the wedge angle is also understood to be the angle at which the beam entry surface and the beam exit surface are arranged in relation to one another.

The fact that the sum of the wedge angles of the first and second number of birefringent optical wedges with the same orientation is equal typically results in the two sub-laser-beams described above maintaining their alignment when passing through the beam switch and being coupled into the inner core of the multi-clad fiber. It is to be understood that a slight deviation of the sum of the wedge angles of the first number of birefringent optical wedges from the sum of the wedge angles of the second number of birefringent optical wedges is tolerable, provided that, in spite of this deviation, the sub-laser-beams can be coupled into the respective light-conducting cores of the multi-clad fiber. The coupling of the two sub-laser-beams into the inner light-conducting core of the multi-clad fiber described above can also be achieved if different wedge angles are used. In this case, it is typically required that the birefringent materials of the birefringent optical wedges are different from one another and the wedge angles of the birefringent optical wedges are matched to the different birefringent materials.

In one embodiment, the beam switch has exactly two birefringent optical wedges which are oppositely oriented and have the same wedge angle. In this embodiment, the multi-clad fiber is typically a generally rotationally symmetrical double-clad fiber having an inner light-conducting core and exactly one annular light-conducting core. As described above, in this case, the two sub-laser-beams exiting the beam switch, the propagation direction of which corresponds to the beam direction of the laser beam, are coupled into the light-conducting inner core and the other two sub-laser-beams exiting the beam switch are coupled into the light-conducting annular core of the double-clad fiber. The two birefringent optical wedges are typically identical in design and rotated by 180° relative to one another such that a beam exit surface of the first birefringent optical wedge in the beam path and a beam entry surface of the second birefringent optical wedge in the beam path are aligned parallel to one another.

In an alternative embodiment, the beam switch has a number N of birefringent optical wedges with the same orientation, which are preferably arranged successively in the beam path of the laser beam. The number N of birefringent optical wedges with the same orientation is: N>1, i.e., there are two or more birefringent optical wedges with the same orientation. It is generally possible that the beam switch consists of the number N of birefringent optical wedges with the same orientation or that the beam switch has no further birefringent optical wedges. In this case, a polarization-influencing device can be arranged between each two birefringent optical wedges following one another in the beam path and, if necessary, additionally in front of the first birefringent optical wedge in the beam path.

In a further development of this embodiment, the beam switch in the beam path of the laser beam has an oppositely oriented birefringent optical wedge in front of the number N of optical wedges with the same orientation. The oppositely oriented birefringent wedge makes it possible to comply with the condition described above that the sums of the wedge angles should be equal.

In the event that the laser beam entering the beam switch has a fixed polarization state, the provision of the oppositely oriented optical wedge can be dispensed with, since in this case no splitting is effected, i.e., in this case a maximum of 2^{N} sub-laser-beams can be generated with the N+1 wedges of the beam switch. Alternatively, the oppositely oriented optical wedge can be replaced by an optical wedge made of a non-birefringent material, for example an amorphous material. If its wedge angle fulfills the condition specified above, after passing through the beam switch, one of the sub-laser-beams is aligned parallel to the beam direction of the laser beam entering the beam switch and is coupled into the core of the multi-clad fiber.

In another further development, the number N of birefringent optical wedges with the same orientation has an identical wedge angle and the oppositely oriented birefringent optical wedge has a wedge angle which corresponds to N times the identical wedge angle. In this way, the condition described above for the sums of the wedge angles of the birefringent optical wedges can be met. As a rule, in this embodiment, a polarization-influencing device is arranged between each two of the birefringent optical wedges.

In a further development, the beam switch has a number N=2 of birefringent optical wedges with the same orientation and the in-coupling optical unit is designed to couple at least three of the sub-laser-beams into different light-conducting cores of a triple-clad fiber or the beam switch has a number N=3 of birefringent optical wedges with the same orientation and the in-coupling optical unit is designed to couple at least four of the sub-laser-beams into different light-conducting cores of a quadruple-clad fiber. The maximum number of sub-laser-beams that can be generated with a number of N birefringent optical wedges is 2^{N}. In the event that an invertly oriented birefringent wedge is arranged in front of the number N of birefringent optical wedges with the same orientation, a maximum number of 2^{N+1} sub-laser-beams can be generated with the help of the beam switch, half of which having a first linear polarization state (s-polarization) and the other half having a second polarization state oriented perpendicular to the first polarization state (p-polarization).

In the case of a triple-clad fiber, a maximum of eight sub-laser-beams can be generated when using three birefringent optical wedges, of which two sub-laser-beams with a different polarization state are coupled into the inner light-conducting core, two pairs of sub-laser-beams, each pair having a different polarization state, are coupled into a first annular light-conducting core and two sub-laser-beams with different polarization states are coupled into a second annular light-conducting core surrounding the first.

In the case of a quadruple-clad fiber, a maximum of sixteen sub-laser-beams can be generated when using four birefringent optical wedges, of which two sub-laser-beams with a different polarization state are coupled into the inner light-conducting core, three pairs of sub-laser-beams, each pair having a different polarization state, are coupled into a first annular light-conducting core, three pairs of sub-laser-beams, each pair having a different polarization state, are coupled into a second annular light-conducting core surrounding the first, and two sub-laser-beams with different polarization states are coupled into a third annular light-conducting core surrounding the second.

Both the triple-clad fiber and the quadruple-clad fiber therefore allow polarization-independent coupling of the sub-laser-beams into the respective light-conducting cores. It is to be understood that the beam switch designed in the manner described above can also be used to couple the sub-laser-beams into multi-clad fibers that have more than three or four light-conducting cores.

In an alternative embodiment, the beam switch has a number N=2 of birefringent optical wedges with the same orientation, wherein a first birefringent optical wedge in the beam path has a wedge angle which is twice as large as a wedge angle of the second birefringent optical wedge in the beam path. This embodiment is particularly suitable for coupling the sub-laser-beams into a quadruple-clad fiber. In this case, the beam switch can only have the two birefringent optical wedges with the same orientation, wherein in this case a maximum of four sub-laser-beams can be coupled into the four light-conducting cores of the quadruple-clad fiber. In this case, a polarization-influencing device is arranged between the two birefringent optical wedges. If necessary, a polarization-influencing device may additionally be provided in front of the first birefringent optical wedge.

In a further development of this embodiment, the beam switch in the beam path of the laser beam has an oppositely oriented birefringent optical wedge in front of the birefringent optical wedges with the same orientation, the wedge angle of which corresponds to three times the wedge angle of the second of the birefringent optical wedges with the same orientation in the beam path. In this way, the condition described above with respect to the wedge angles of the birefringent optical wedges can be met. In the event that the incident laser beam has a direction of polarization that is oriented perpendicular or parallel to the optical axis of the birefringent optical wedges, the oppositely oriented birefringent optical wedge can be omitted or replaced by an optical wedge made of a non-birefringent material.

In a further development of this embodiment, the in-coupling optical unit is designed for coupling at least one sub-laser-beam, preferably at least one pair of sub-laser-beams, with two different polarization states, into a light-conducting core of a rotationally symmetrical quadruple-clad fiber. Even with the beam switch designed in the manner described above, a polarization-independent coupling of the sub-laser-beams into the light-conducting cores of the quadruple-clad fiber can be achieved.

In the embodiment described here, the beam switch typically has two polarization-influencing devices, which are arranged between two birefringent optical wedges that follow one another in the beam path. In principle, it is possible with the beam switch described here to couple 100% of the power of the laser beam into each of the light-conducting cores. However, due to the fact that there are only two degrees of freedom for adjusting the splitting ratios between the light-conducting cores, the power of the laser beam cannot be distributed arbitrarily among the four light-conducting cores of the quadruple-clad fiber.

In a further embodiment, the device comprises a control device for adjusting the polarization-influencing effect of the at least one polarization-influencing device in order to adjust a splitting ratio of the laser beam when coupling into the at least two different light-conducting cores of the multi-clad fiber. The control device is used to electronically control the polarization-rotating device. The polarization-influencing device allows for changing the polarization state of each incident sub-laser-beam. This change may, for example, be a rotation of the electric field strength vector of a respective incident sub-laser-beam by an angle of rotation about the respective propagation direction of the sub-laser-beam.

Typically, the polarization-influencing device is designed for continuous adjustment of the polarization-influencing effect. As described above, a rotatably mounted delay plate can be used as a polarization-influencing device. If the device has a polarization-rotating effect, the angle of rotation can, for example, be continuously changed or adjusted. In this case, the polarization-influencing device can be, for example, a delay plate in the form of a rotatably mounted λ/2 plate, which can be rotated about the optical axis of the beam switch with the aid of the control device acting on a suitable actuator. The polarization-influencing device can alternatively be a Pockels cell, which can also be controlled electronically and which influences the polarization state, in particular a rotation of the direction of polarization, of an incident sub-laser-beam.

In a further embodiment, the control device is designed to adjust a polarization-influencing effect of the at least one polarization-influencing device, in which no power of the laser beam is coupled into at least one of the light-conducting cores of the multi-clad fiber and/or in which the entire power of the laser beam is coupled into at least one of the light-conducting cores of the multi-clad fiber.

In the event that the number of polarization-influencing devices in the form of polarization-rotating devices corresponds to the number of light-conducting cores of the multi-clad fiber minus one, it is typically possible to set any splitting ratio between the light-conducting cores, i.e., the power of the laser beam can be distributed arbitrarily between the light-conducting cores. Between 0% and 100% of the power of the laser beam can thus be coupled into a respective light-conducting core. In the first case (coupling of 0%), no sub-laser-beams are coupled into the respective light-conducting core; in the second case, all sub-laser-beams exiting the beam switch are coupled into the respective light-conducting core. For example, in the case of a double-clad fiber, the entire power of the laser beam can be coupled into the inner light-conducting core if the polarization-influencing device does not produce a polarization-influencing effect. In the event that the polarization-influencing device causes a polarization rotation of 90°, the entire power of the laser beam can be coupled into the annular light-conducting core of the double-clad fiber.

In a further embodiment, the laser beam entering the beam switch is linearly polarized and the beam switch has a λ/4 delay element in the beam path in front of the first birefringent optical wedge. The λ/4 delay element can, for example, be designed as a λ/4 plate, the preferred axis of which is aligned at 45° to the optical axis of the birefringent optical wedges of the beam switch. In this case, the power of the laser beam is aligned parallel or perpendicular to the optical axis of the birefringent optical wedges by the λ/4 delay element with a splitting ratio of 50:50, regardless of the alignment of the linear polarization of the incoming laser beam. This results in two sub-laser-beams coupled into the same light-conducting core always having the same power.

Embodiments of the invention also relate to an optical system comprising: a multi-clad fiber, preferably a double-clad fiber, a triple-clad fiber or a quadruple-clad fiber, and a device designed as described above for coupling the laser beam into the multi-clad fiber. The optical system typically also comprises a laser that is used to generate the laser beam that is coupled into the beam switch. The laser wavelength of the laser beam is basically arbitrary and adapted to the material of the optical elements of the beam switch, the in-coupling optical unit and the multi-clad fiber. In the event that the wavelength of the laser beam is 1030 nm, the birefringent optical wedges can, for example, be made of crystalline quartz, which is transparent to this wavelength.

In the optical system described above, the power distribution in the multi-clad fiber can be adjusted using the polarization-influencing devices independently of the polarization of the laser beam entering the beam switch. The power distribution in the multi-clad fiber is also independent of the spatial intensity distribution of the incoming laser beam and largely independent of the pointing of the incoming laser beam.

The features mentioned above and those yet to be presented may be used in each case alone or jointly in any desired combinations. The embodiments shown and described should not be understood as an exhaustive list, but rather are of an exemplary character.

In the following description of the drawings, identical reference signs are used for identical or functionally identical components.

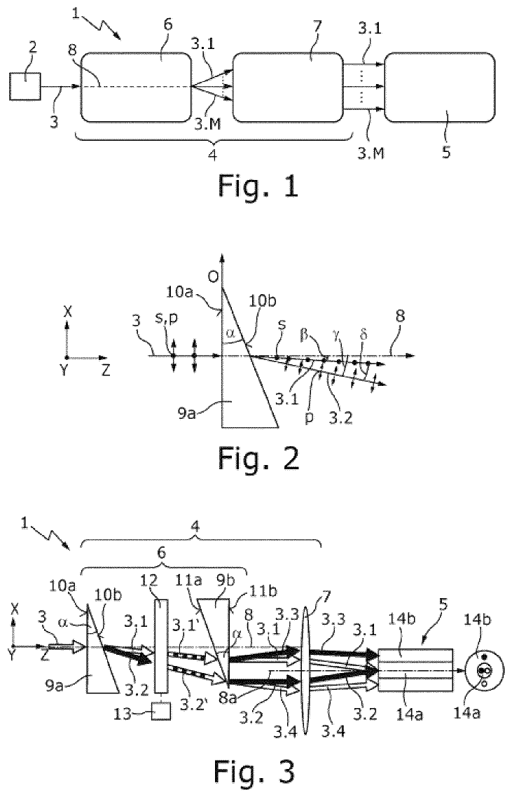

FIG. 1 shows an optical system 1 having a laser 2 for generating a laser beam 3. The laser beam 3 exiting the laser 2 enters a device 4 which is designed for coupling the laser beam 3 into a multi-clad fiber 5. The device 4 has a beam switch 6 and an in-coupling optical unit 7. The beam switch 6 serves for dividing the laser beam 3 into a typically even number of sub-laser-beams 3.1, . . . , 3.M, which exit the beam switch 6. In the example shown in FIG. 1, two of the sub-laser-beams 3.1, . . . , 3.M extend parallel to an optical axis 8 of the beam switch 6, while the remaining sub-laser-beams 3.1, . . . , 3.M are each aligned at an angle to the optical axis 8 of the beam switch 6.

With the help of the in-coupling optical unit 7, the angular distribution of the sub-laser-beams 3.1, 3.2, . . . is converted into a spatial distribution at an end face of the multi-clad fiber 5, which lies in the focal plane of the in-coupling optical unit 7. The exit angles of the sub-laser-beams 3.1, 3.2, . . . from the beam switch 6 are matched to the in-coupling optical unit 7 and lead to spatial offsets in the focal plane of the in-coupling optical unit 7, which are matched to the multi-clad fiber 5 in such a way that the sub-laser-beams 3.1, 3.2, . . . are coupled into the multi-clad fiber 5 at the positions of two or more light-conducting cores. In the simplest case, the in-coupling optical unit 7 can be a focusing lens, but the in-coupling optical unit 7 can also have several transmitting or reflecting optical elements.

The multi-clad fiber 5 can be a linear multi-clad fiber in which several light-conducting cores are arranged next to one another, into which the sub-laser-beams 3.1, 3.2, . . . are coupled. Alternatively, it can be a grid-like multi-clad fiber in which several light-conducting cores are arranged in rows and columns, or a rotationally symmetrical multi-clad fiber.

For dividing the laser beam 3 into the plurality of sub-laser-beams 3.1, 3.2, . . . , the beam switch 6 has at least two birefringent optical wedges. The effect of a first optical wedge 9a of the beam switch 6 in the beam path on the laser beam 3 is described in more detail below with reference to FIG. 2. The laser beam 3 has two polarization components s, p, in which the electric field strength vector is aligned parallel to the plane of the drawing or perpendicular to the plane of the drawing, which corresponds to the XZ-plane of an XYZ-coordinate system. The birefringent optical wedge 9a is made of a uniaxial crystal, for example quartz or calcite. The optical axis O of the birefringent optical wedge 9a is aligned perpendicular to the optical axis 8 of the beam switch 6 (in the X-direction). When passing through the optically anisotropic birefringent material of the birefringent optical wedge 9a, the laser beam 3 is divided into a first, s-polarized sub-laser-beam 3.1 and a second, p-polarized sub-laser-beam 3.2. The first sub-laser-beam 3.1, which forms the ordinary beam, is aligned at a first angle β to the optical axis 8. The second sub-laser-beam 3.2, which forms the extraordinary beam, is aligned at a second angle γ to the optical axis 8. When passing through the birefringent optical wedge 8a, an angular difference δ=γ−β is thus generated between the first and second sub-laser-beams 3.1, 3.2. The amount of the angular difference δ depends on the type of birefringent material used and on the wedge angle α of the birefringent optical wedge 9a. The angular difference δ together with the focal length f of the in-coupling optical unit 7 determines a lateral distance Δx of the first and second sub-laser-beams 3.1, 3.2 in the focal plane of the in-coupling optical unit 7, whereby the following approximately applies: Δx=fδ.

In the example shown in FIG. 2, a beam entry surface 10a of the birefringent optical wedge 9a is aligned perpendicular to the optical axis 8 of the beam switch 6. A beam exit surface 10b of the birefringent optical wedge 8a is aligned with respect to the XY-plane perpendicular to the optical axis 8 at the wedge angle α.

FIG. 3 shows an optical system 1 with a beam switch 6, which has a first birefringent optical wedge 9a in the beam path, which is designed as in FIG. 2. A second birefringent optical wedge 9b in the beam path is of the same construction or identical to the first birefringent optical wedge 9a and is rotated by 180° relative to the same in the XZ-plane, which corresponds to the plane of the drawing. Here, the beam exit surface 10b of the first birefringent optical wedge 9a is aligned parallel to a beam entry surface 11a of the second birefringent optical wedge 9b. A beam exit surface 11b of the second birefringent optical wedge 9b is aligned perpendicular to the optical axis 8 of the beam switch 6. The wedge angles α of the two birefringent optical wedges 9a, 9b are equal in size.

The laser beam 3 entering the beam switch 6 passes through the first birefringent optical wedge 9a and is divided into the two sub-laser-beams 3.1, 3.2, as described in connection with FIG. 2. The two sub-laser-beams 3.1, 3.2 impinge on a polarization-influencing device 12, which is designed in the form of a rotatable λ/2 plate. The polarization-influencing device 12 in the form of the rotatable λ/2 plate has a polarization-rotating effect and is therefore referred to below as the polarization-rotating device 12. A control device 13 is used to electronically control the polarization-rotating device 12. In the example shown, the control device 13 is used to rotate the λ/2 plate about the optical axis 8 of the beam switch 6. In this way, the polarization-rotating effect of the polarization-rotating device 12, more precisely the angle of rotation when rotating the direction of polarization, can be continuously adjusted. By rotating the direction of polarization, an exiting first sub-laser-beam 3.1′, which has both an s-polarized and a p-polarized polarization component, is formed from the s-polarized first sub-laser-beam 3.1, which enters the polarization-rotating device 12. Accordingly, an exiting second sub-laser-beam 3.2′ is formed from the p-polarized second sub-laser-beam 3.2, which has s- and p-polarized polarization components.

The two sub-laser-beams 3.1′, 3.2′ exiting the polarization-rotating device 12 pass through the second birefringent optical wedge 9b in the beam path and are divided here into a total of four sub-laser-beams 3.1 to 3.4. Two of the sub-laser-beams 3.1, 3.2 exit the second birefringent wedge 9b aligned parallel to the optical axis 8. The two other sub-laser-beams 3.3, 3.4 exit the second birefringent optical wedge 9b at an angle to the optical axis 8 of the beam switch 6.

As can also be seen in FIG. 3, the first and second sub-laser-beams 3.1, 3.2, which are aligned parallel to the incident laser beam 3 or to the optical axis 8 of the beam switch 6 when exiting the beam switch 6, are coupled into an inner light-conducting core 14a of the multi-clad fiber 5, which is designed as a rotationally symmetrical double-clad fiber. The third and fourth sub-laser-beams 3.3, 3.4 are coupled into a second light-conducting core 14b of the double-clad fiber 5, which is designed to be annular and surrounds the inner light-conducting core 14a, as can be seen from the cross-section of the double-clad fiber 5 shown on the right in FIG. 3. An optical axis 8a of the in-coupling optical unit 7 and the central axis of the double-clad fiber 5 are laterally offset here with respect to the optical axis 8 of the beam switch 6, namely by the amount by which the two sub-laser-beams 3.1, 3.2 were offset parallel to the optical axis 8 at the exit from the beam switch 6 with respect to the incident laser beam 3. This makes it possible for the sub-laser-beams 3.1, 3.2, . . . to impinge on the entry end of the double-clad fiber 5 with the smallest possible angles of incidence.

In FIG. 3, s-polarized sub-laser-beams 3.1, 3.4 are shown using white arrows and p-polarized sub-laser-beams 3.2, 3.3 are shown using black arrows. As can be seen in FIG. 3, a first pair of sub-laser-beams 3.1, 3.2 with different polarization states (s-polarization or p-polarization) are coupled into the inner light-conducting core 14a of the double-clad fiber 5 and a second pair of sub-laser-beams 3.3, 3.4 with different polarization states (s-polarization or p-polarization) are coupled into the annular light-conducting core 14b of the double-clad fiber 5. Both in the inner light-conducting core 14a and in the annular light-conducting core 14b, the number of s-polarized or p-polarized sub-laser-beams 3.1, 3.2 and 3.3, 3.4 is the same, i.e., the coupling of the laser beam 3 into the respective cores 14a, 14b of the double-clad fiber 5 occurs independently of polarization.

The splitting ratio, i.e., the respective proportion of the power of the laser beam 3 which is coupled into the inner light-conducting core 14a and into the annular light-conducting core 14b, can be adjusted by controlling the polarization-influencing device 12 with the aid of the control device 13. In principle, the power of the laser beam 3 can be distributed as desired between the two light-conducting cores 14a, 14b, i.e., between 0% and 100% of the power of the laser beam 3 can be coupled into a respective light-conducting core 14a, 14b. The polarization-rotating effect of the polarization-rotating device 12 can in particular be selected such that no power of the laser beam 3 is coupled into a respective light-conducting core 14a, 14b, while the entire power of the laser beam 3 is coupled into the respectively other light-conducting core 14b, 14a.

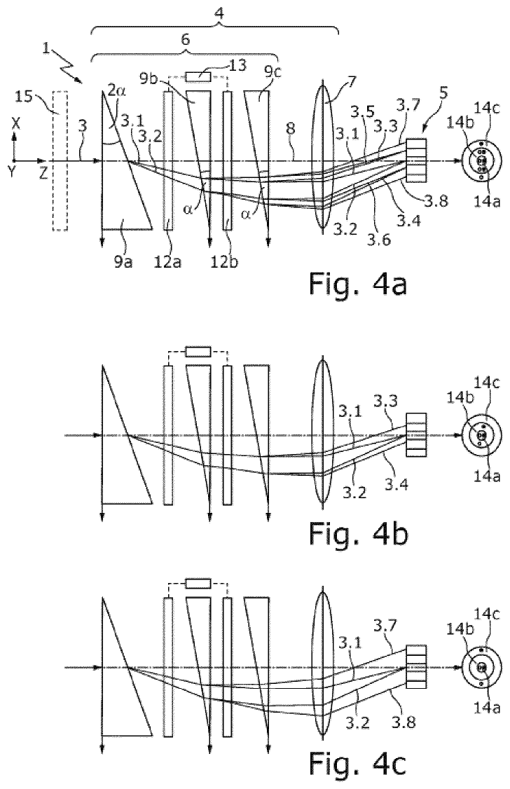

FIG. 4a-c show an optical system 1 in which the multi-clad fiber 5 is designed as a triple-clad fiber and has an inner light-conducting core 14a and two annular light-conducting cores 14b, 14c which surround the inner light-conducting core 14a. As can be seen in FIG. 4a, the beam switch 6 is designed in this case to divide the incident laser beam 3 into a total of eight sub-laser-beams 3.1 to 3.8. For this purpose, the beam switch 6 has three birefringent optical wedges 9a, 9b, 9c. The second and third birefringent optical wedges 9b, 9c in the beam path have the same orientation with respect to the optical axis 8, the first birefringent optical wedge 9a in the beam path is oriented opposite to the second and third birefringent optical wedges 9b, 9c in the beam path.

The second and third birefringent optical wedges 9b, 9c in the beam path have the same wedge angle α. The first birefringent optical wedge 9a in the beam path has a wedge angle 2α which is twice as large as the wedge angle α of the second and third birefringent optical wedges 9b, 9c. The three birefringent optical wedges 9a-c are made of the same birefringent optical material.

Two sub-laser-beams 3.1, 3.2 of the total of eight sub-laser-beams 3.1 to 3.8 that exit the beam switch 6 are aligned parallel to the optical axis 8 of the beam switch 6 or to the incident laser beam 3 and are coupled by the in-coupling optical unit 7 and into the inner light-conducting core 14a of the multi-clad fiber 5 as described in connection with FIG. 3. To simplify the representation, the lateral offset between the optical axis 8 of the beam switch 6 and the optical axis 8a of the in-coupling optical unit 7 is not shown in FIG. 4a-c and in the following representations. Of the remaining six sub-laser-beams 3.3 to 3.8, four sub-laser-beams 3.3 to 3.6 are coupled into the second light-conducting core 14b of the triple-clad fiber 5 and two sub-laser-beams 3.7, 3.8 are coupled into the third light-conducting core 14c of the triple-clad fiber 5. The sub-laser-beams 3.1, 3.2; 3.3 to 3.6; 3.7, 3.8 coupled into the respective core 14a-c are each differently polarized in pairs, as indicated in FIG. 4a by circles drawn in the cross-section of the triple-clad fiber 5. Here, white circles correspond to s-polarized sub-laser-beams, while black circles correspond to p-polarized sub-laser-beams.

As can also be seen in FIG. 4a, the beam switch 6 has two polarization-rotating devices 12a, 12b, which are electronically controlled by means of the control device 13 in order to distribute the power of the laser beam 3 to the three light-conducting cores 14a-c of the triple-clad fiber. Also in the device 4 shown in FIG. 4a, between 0% and 100% of the power of the laser beam 3 can be coupled into a respective light-conducting core 14a-c.

FIG. 4b shows the case in which the control device 13 controls the first polarization-rotating device 12a in the beam path in such a way that it has no polarization-rotating effect, i.e., the optical axis of the λ/2 plate is aligned either in the X-direction or in the Y-direction. This has the consequence that no splitting of the two sub-laser-beams 3.1, 3.2, which were formed at the first birefringent optical wedge 9a, occurs at the second birefringent optical wedge 9b. Accordingly, in this case, the beam switch 6 generates only four sub-laser-beams 3.1 to 3.4, which are coupled into the first and second light-conducting cores 14a, 14b.

By adjusting the polarization-rotating effect of the second polarization-rotating device 12b, the splitting ratio during coupling into the first and second light-conducting cores 14a, 14b can be adjusted. If the second polarization-rotating device 12b has no polarization-rotating effect because its optical axis is aligned in the X-direction or in the Y-direction, only the first and second sub-laser-beams 3.1, 3.2 emerge from the beam switch 6 and are coupled into the inner light-conducting core 14a. If the optical axis of the second polarization-rotating device 12b is aligned at 45° to the X-direction and Y-direction, two sub-laser-beams 3.3, 3.4 are generated, which are coupled into the first annular light-conducting core 14b.

FIG. 4c shows the case in which the control device 13 controls the second polarization-rotating device 12a in the beam path in such a way that it has no polarization-rotating effect, i.e., the optical axis of the λ/2 plate is aligned either in the X-direction or in the Y-direction. In this case, the four sub-laser-beams 3.1, 3.2, 3.7, 3.8, which were formed when passing through the second birefringent optical wedge 9b, are not split at the third birefringent optical wedge 9c in the beam path. Accordingly, in this case, the beam switch 6 generates only four sub-laser-beams 3.1, 3.2, 3.7, 3.8, which are coupled into the first and third light-conducting cores 14a, 14c. By adjusting the polarization-rotating effect of the first polarization-rotating device 12a, the splitting ratio during coupling into the first and third light-conducting cores 14a, 14c can also be adjusted in this case. If the first polarization-rotating device 12a has no polarization-rotating effect, only the first and second sub-laser-beams 3.1, 3.2 emerge from the beam switch 6 and are coupled into the inner light-conducting core 14a. If the optical axis of the first polarization-rotating device 12a is aligned at 45° to the X-direction or Y-direction, two sub-laser-beams 3.7, 3.8 are generated, which are coupled into the second annular light-conducting core 14c.

In the event that the same power is to be coupled into all three light-conducting cores 14a-c, the first polarization-rotating device 12a in the form of the λ/2 plate is aligned at an angle of 22.5° to the X-direction or the Y-direction. The second polarization-rotating device 12b in the form of the λ/2 plate is aligned at an angle of 17.63° to the X-direction or the Y-direction. In the device 4 described in FIG. 4a-c, it is fundamentally advantageous if the distances between the light-conducting cores 14a-c or between the sub-laser-beams 3.1, 3.2, . . . coupled into adjacent light-conducting cores 14a-c are approximately equal in size.

In the event that the incident laser beam 3 is linearly polarized, a λ/4 delay element 15 indicated in FIG. 4a can be arranged in the beam path in front of the first birefringent optical wedge 9a. In this case, the optical axis of the λ/4 delay element 15 is aligned at 45° to the X-direction or to the optical axis of the first birefringent optical wedge 9a. The power of the linearly polarized laser beam 3 is divided by the λ/2 delay element 15 with a splitting ratio of 50:50 into two polarization components aligned in the X-direction or in the Y-direction respectively, wherein the division is independent of the alignment of the electric field strength vector of the incident linearly polarized laser beam 3. This results in two sub-laser-beams 3.1, 3.2, . . . with different polarization states, which are coupled into the same light-conducting core 14a-c of the triple-clad fiber 5, having the same power.

In the event that the incident laser beam 3 is linearly polarized and its electric field strength vector is oriented in the X-direction or in the Y-direction, a maximum of four sub-laser-beams 3.1, 3.2, . . . can be generated in the beam switch 6. In this case, the first birefringent optical wedge 9a can be omitted. Alternatively, instead of the first birefringent optical wedge 9a, an optical wedge can be arranged in the beam switch 6 which is not made of a birefringent material and which has a wedge angle of 2α.

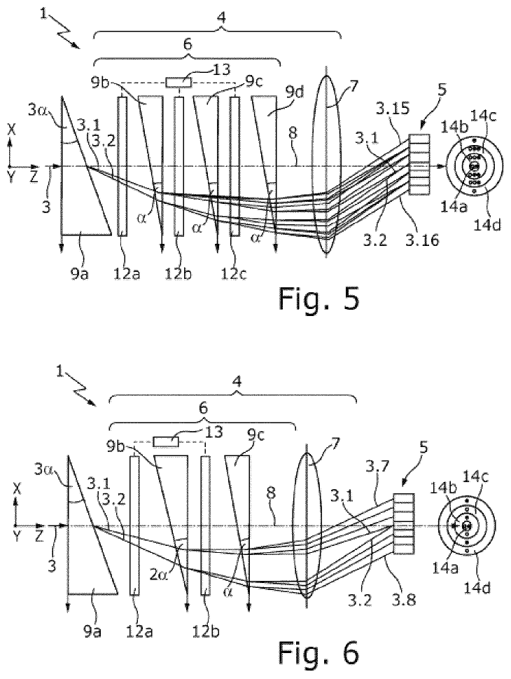

FIG. 5 shows a device 4 which is designed for coupling the laser beam 3 into a radially symmetrical quadruple-clad fiber 5 which has an inner light-conducting core 14a and three annular light-conducting cores 14b-d which surround the inner light-conducting core 14a. The device 4 shown in FIG. 5 differs from the device 4 shown in FIG. 4a-c in that it has three birefringent optical wedges 9b, 9c, 9d with the same orientation and three polarization-rotating devices 12a-c, which are arranged between two birefringent optical wedges 9a, 9b; 9b, 9c; 9c, 9d that follow one another in the beam path. A first birefringent optical wedge 9a in the beam path has a wedge angle 3α which corresponds to three times the (identical) wedge angles α of the three wedges 9b-c with the same orientation.

The beam switch 6 of the device 4 shown in FIG. 5 makes it possible to couple a maximum of sixteen sub-laser-beams 3.1 to 3.16 into the quadruple-clad fiber 5. The division into the sub-laser-beams 3.1 to 3.16 is carried out in the manner described above in connection with FIG. 4a-c. Two of the sub-laser-beams 3.1, 3.2 exit the beam switch 6 parallel to the incident laser beam 3 and are coupled into the inner light-conducting core 14a of the quadruple-clad fiber 5. In each case, six of the sub-laser-beams 3.1 to 3.16 are coupled into the first and second annular light-conducting cores 14b, 14c, and two of the sub-laser-beams 3.1 to 3.16 are coupled into the third annular light-conducting core 14d. The splitting ratio is adjusted by means of the three polarization-rotating devices 12a-c in the manner described in connection with FIG. 4a-c.

In the event that the incident laser beam 3 is linearly polarized and its electric field strength vector is oriented in the X-direction or in the Y-direction, a maximum of eight sub-laser-beams 3.1, 3.2, . . . can be generated in the beam switch 6. In this case, the first birefringent optical wedge 9a can be omitted or, alternatively, instead of the first birefringent optical wedge 9a, an optical wedge can be arranged in the beam switch 6 which is not made of a birefringent material and which has a wedge angle of 3α. The material of the optical wedge can be an amorphous (glass) material, for example quartz glass.

FIG. 6 shows a device 4 which, like the device 4 shown in FIG. 5, is designed for coupling the laser beam 3 into a quadruple-clad fiber 5. The device 4 has three birefringent optical wedges 9a-c. The second and third birefringent optical wedges 9b, 9c in the beam path have the same orientation, the first birefringent optical wedge 9a in the beam path is oppositely oriented to the other two wedges 9b, 9c. The second birefringent optical wedge 9b has a wedge angle 2α which is twice as large as the wedge angle α of the third birefringent optical wedge 9c. The first birefringent optical wedge 9a has a wedge angle 3α which is three times as large as the wedge angle α of the third birefringent optical wedge 9c.

As can be seen in FIG. 6, the beam switch 6 is designed to generate up to eight sub-laser-beams 3.1 to 3.8. Two differently polarized sub-laser-beams 3.1, 3.2, . . . are, in each case, coupled into one of the light-conducting cores 14a-d of the quadruple-clad fiber 5. Two of the sub-laser-beams 3.1, 3.2, which exit the beam switch 6 and are aligned parallel to the optical axis 8 or to the beam direction Z of the incident laser beam 3, are coupled here into the inner light-conducting core 14a of the quadruple-clad fiber 5.

In the event that the incident laser beam 3 is linearly polarized and its electric field strength vector is oriented in the X-direction or in the Y-direction, a maximum of four sub-laser-beams 3.1, 3.2, . . . can be generated in the beam switch 6. In this case, the first birefringent optical wedge 9a can be omitted or, alternatively, instead of the first birefringent optical wedge 9a, an optical wedge can be arranged in the beam switch 6 which is made of an amorphous material. The optical wedge should have a wedge angle of 3α.

The device 4 shown in FIG. 6 has two polarization-rotating devices 12a, 12b. Therefore, only two degrees of freedom are available for distributing the power of the laser beam 3 to the four light-conducting cores 14a-d of the quadruple-clad fiber 5. Unlike the examples described above, an arbitrary distribution of the power of the laser beam 3 between the four light-conducting cores 14a-d is therefore not possible, i.e., arbitrary splitting ratios cannot be set. However, it is still possible to couple the entire power of the laser beam 3 into one of the light-conducting cores 14a-d.

Instead of the polarization-rotating devices 12, 12a, 12b described above in the form of rotatable λ/2 plates, polarization-influencing devices 12, 12a, 12b, . . . can also be used, which have a delaying effect that changes the polarization state of the laser beam 3 or the sub-beams 3.1, 3.2, . . . , but do not cause a rotation of the direction of polarization. For example, the polarization-influencing devices 12, 12a, 12b, . . . can be rotatable λ/4 plates

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A device for coupling a laser beam into a multi-clad fiber, the device comprising:
a beam switch for dividing the laser beam into a plurality of sub-laser-beams, wherein the beam switch comprises at least two birefringent optical wedges, and at least one polarization-influencing device having an adjustable polarization-influencing effect and being arranged between the at least two birefringent optical wedges, and
an in-coupling optical unit for coupling the plurality of sub-laser-beams exiting the beam switch into the multi-clad fiber, wherein the in-coupling optical unit is configured to couple at least two of the plurality of sub-laser-beams exiting the beam switch into at least two different light-conducting cores of the multi-clad fiber.

2. The device according to claim 1, wherein the multi-clad fiber is configured to be rotationally symmetrical and has an inner light-conducting core and at least one annular light-conducting core, and wherein the in-coupling optical unit is configured to couple two sub-laser-beams of the plurality of sub-laser-beams exiting the beam switch with different polarization states propagating in a propagation direction corresponding to a beam direction of the laser beam entering the beam switch into the inner light-conducting core of the multi-clad fiber.

3. The device according to claim 1, wherein the in-coupling optical unit is configured to couple each pair of one or more pairs of sub-laser-beams of the plurality of sub-laser-beams into a respective light-conducting core of the multi-clad fiber, each pair having two different polarization states.

4. The device according to claim 1, wherein the beam switch comprises a first number of birefringent optical wedges with a same orientation, and a second number of birefringent optical wedges oriented opposite to the first number of birefringent optical wedges, wherein a sum of wedge angles of the first number of birefringent optical wedges corresponds to a sum of wedge angles of the second number of birefringent optical wedges.

5. The device according to claim 1, wherein the beam switch comprises exactly two birefringent optical wedges oppositely oriented with respect to each other and having a same wedge angle.

6. The device according to claim 1, wherein the beam switch comprises a number N of birefringent optical wedges with a same orientation, arranged successively in a beam path of the laser beam.

7. The device according to claim 6, wherein the beam switch in the beam path of the laser beam comprises an oppositely oriented birefringent optical wedge in front of the number N of optical wedges with the same orientation.

8. The device according to claim 7, wherein the number N of birefringent optical wedges with the same orientation has an identical wedge angle, and wherein the oppositely oriented birefringent optical wedge has a wedge angle that corresponds to N times the identical wedge angle.

9. The device according to claim 6, wherein the number N is equal to 2, the multi-clad fiber is a triple-clad fiber, and the in-coupling optical unit is configured for coupling at least three of the plurality of sub-laser-beams into different light-conducting cores of the triple-clad fiber, or
wherein the number N is equal to 3, the multi-clad fiber is a quadruple-clad fiber, and the in-coupling optical unit is configured for coupling at least four of the plurality of sub-laser-beams into different light-conducting cores of the quadruple-clad fiber.

10. The device according to claim 6, wherein the number N of birefringent optical wedges with the same orientation comprises a first birefringent optical wedge and a second birefringent optical wedge, wherein the first birefringent optical wedge in the beam path has a wedge angle that is twice as large as a wedge angle of the second birefringent optical wedge in the beam path.

11. The device according to claim 10, wherein the beam switch in the beam path of the laser beam comprises an oppositely oriented birefringent optical wedge in front of the first birefringent optical wedge and the second birefringent optical wedge with the same orientation, having a wedge angle corresponding to three times the wedge angle of the second birefringent optical wedge.

12. The device according to claim 10, wherein the multi-clad fiber is a rotationally symmetrical quadruple-clad fiber, and wherein the in-coupling optical unit is configured for coupling at least one pair of sub-laser-beams with two different polarization states into a light-conducting core of the rotationally symmetrical quadruple-clad fiber.

13. The device according to claim 1, further comprising a control device for adjusting the polarization-influencing effect of the at least one polarization-influencing device in order to adjust a splitting ratio of the laser beam when coupling into the at least two different light-conducting cores of the multi-clad fiber.

14. The device according to claim 13, wherein the control device is configured to adjust the polarization-influencing effect of the at least one polarization-influencing device, so that no power of the laser beam is coupled into at least one of the at least two light-conducting cores of the multi-clad fiber, and/or an entire power of the laser beam is coupled into at least one of the at least two light-conducting cores of the multi-clad fiber.

15. The device according to claim 1, wherein the laser beam entering the beam switch is linearly polarized, and the beam switch comprises a λ/4 delay element in a beam path in front of a first birefringent optical wedge.

16. An optical system comprising:
a multi-clad fiber, and
a device according to claim 1 for coupling the laser beam into the multi-clad fiber.
